(19) United States
(12) Patent Application Publication
(10) Pub. No.: US 2021/0110477 A1
(43) Pub. Date: Apr. 15, 2021

(54) System and Method of Patent Debt Financing Pooling

(71) Applicants: ERICH LAWSON SPANGENBERG, Paris (FR); Brian Joshua Berman, Long Island City, NY (US)

(72) Inventors: ERICH LAWSON SPANGENBERG, Paris (FR); Brian Joshua Berman, Long Island City, NY (US)

(21) Appl. No.: 17/029,949

(22) Filed: Sep. 23, 2020

Related U.S. Application Data
(60) Provisional application No. 62/906,000, filed on Sep. 25, 2019.

(51) Int. Cl. G06Q 40/06; G06Q 40/02; G06Q 20/36; G06Q 50/18; H04L 9/06

(52) U.S. Cl. CPC G06Q 40/06; G06Q 40/025; H04L 2209/38; G06Q 50/184; H04L 9/0643; G06Q 20/36

(57) ABSTRACT

This invention provides solutions for patent debt financing. In one embodiment, there is pooling of Patent Owners. There can be at least two Patent Owners pooling patent(s) together. This provides for diversification. Pooling makes it easier to get the asset class rated by a ratings agency. Pooling makes it more attractive to Lenders, since there is less risk of default. In another embodiment, a Patent Owner can combine or pool patents from different technology areas into one portfolio. This provides for diversification. Pooling makes it easier to get the asset class rated by a ratings agency. Pooling makes it more attractive to Lenders, since there is less risk of default.

### PRIORITY CLAIMS

This application claims the benefit of U.S. Provisional Patent Application Ser. No. 62/906,000, filed Sep. 25, 2020, the contents of which are incorporated herein by reference.

### FIELD OF THE INVENTION

This invention deals with patent debt financing and patent equity financing.

### BACKGROUND

The problem is the current patent debt financing has limitations and drawbacks.

### SUMMARY OF INVENTION

This invention provides solutions for patent debt financing.

In one embodiment for patent debt financing, there is pooling of Patent Owners. There can be at least two Patent Owners pooling patent(s) together. This provides for diversification. Pooling makes it easier to get the asset class rated by a ratings agency. Pooling makes the patent portfolio more attractive to Lenders, since there is less risk of default by the Borrower/Patent Owner.

In another embodiment for patent debt financing, at least one Patent Owner can combine or pool patents from different technology areas into one portfolio. This provides for diversification. Pooling makes it easier to get the asset class rated by a ratings agency. Pooling makes it more attractive to Lenders, since there is less risk of default.

In another embodiment for patent debt financing, there is pooling of Patent Owners. There can be at least two Patent Owners. At least one of the Patent Owners can have at least two different technology areas of patents.

This invention provides solutions for patent equity financing solution.

In one embodiment for patent equity financing, there is pooling of Patent Owners. There can be at least two Patent Owners pooling patent(s) together. This provides for diversification. Pooling makes it easier to get the asset class rated by a ratings agency. Pooling makes it more attractive to equity investors.

In another embodiment for patent equity financing, at least one Patent Owner can combine or pool patents from different technology areas into one portfolio. This provides for diversification. Pooling makes it easier to get the asset class rated by a ratings agency. Pooling makes it more attractive to equity investors.

In another embodiment for patent equity financing, there is pooling of Patent Owners. There can be at least two Patent Owners. At least one of the Patent Owners can have at least two different technology areas of patents.

This invention provides for solutions for a combined patent debt and patent equity financing solution.

In one embodiment, a Patent Owner can seek or pursue both patent debt and patent equity simultaneously at the same time. This is attractive to Lenders, since by showing progress of raising equity from equity investors (such as Series A, Series B, etc.), then Lenders see signs of positive progress and are more likely to lend money since there is a higher chance or increased likelihood to pay off the loan.

Similar to fantasy sports, a person can pick a fantasy draft of patents that will perform the best, including based on sale value, licensing revenue, royalties, etc. This fantasy draft could be just one patent from one company. It could include multiple companies. It could include multiple technology areas from one company. It could include multiple technology areas from more than one company.

If someone picks a patent to include in their fantasy sports, the patent owner (or Patent Applicant or Assignee) might choose to reward those people such as giving them rewards, incentives, dividends, cash, loyalty points, discounted or free tickets to events, coupons, or any other item or reward.

Someone could create their own portfolio of patents in fantasy sports, such as a person could select 6 patents, including Patent Owner 1 with patents A, B, C and Patent Owner 2 with patents D, E, F. Then, in the future, anyone else who selects these same 6 patents could lead to a reward being paid to this person who created this fantasy sports portfolio of patents A, B, C, D, E, F.

There could be a Bloomberg type analysis charting the performance of all patents, patent applications of individual patents and groups of patent portfolios. The Bloomberg analysis can have total value of each patent and of the portfolio or groups of patents.

In one embodiment, the patent debt financing can be rated by a rating agency, such as Moody's, Standard & Poors (S&P), Fitch Ratings, Kroll Bond Rating Agency (KBRA), DBRS, etc.

A mutual fund could include both patent and non-patent assets.

### BRIEF DESCRIPTION OF THE DRAWINGS

The various embodiments are illustrated by way of example, and not by way of limitation, in the figures of the accompanying drawings:

Having thus described the invention in general terms, reference will now be made to the accompanying drawings, which are not necessarily drawn to scale, and wherein:

FIG. 1 is diagram of the core structure of the present invention.

FIG. 2 is a diagram of the smart securities process for patent assets using the present invention.

FIG. 3 is a diagram of the patent sale assignment process of the present invention.

FIG. 4 is a diagram of the patent license agreement process of the present invention.

FIG. 5 is an illustration depicting an exemplary operating environment including one or more user computers, computing devices, or processing devices, which can be used to operate a client, such as a dedicated application, web browser is shown.

FIG. 6 is another illustration depicting an exemplary operating environment including a computer system with various elements as shown.

### DETAILED DESCRIPTION OF THE PREFERRED EMBODIMENT

This invention provides solutions for patent debt financing and patent equity financing.

In one embodiment for patent debt financing, there is pooling of Patent Owners. There can be at least two Patent Owners pooling patent(s) together. This provides for diversification. Pooling makes it easier to get the asset class rated by a ratings agency. Pooling makes the patent portfolio more attractive to Lenders, since there is less risk of default by the Borrower/Patent Owner.

In another embodiment for patent debt financing, at least one Patent Owner can combine or pool patents from different technology areas into one portfolio. This provides for diversification. Pooling makes it easier to get the asset class rated by a ratings agency. Pooling makes it more attractive to Lenders, since there is less risk of default.

In another embodiment for patent debt financing, there is pooling of Patent Owners. There can be at least two Patent Owners. At least one of the Patent Owners can have at least two different technology areas of patents.

In one embodiment for patent equity financing, there is pooling of Patent Owners. There can be at least two Patent Owners pooling patent(s) together. This provides for diversification. Pooling makes it easier to get the asset class rated by a ratings agency. Pooling makes it more attractive to equity investors.

In another embodiment for patent equity financing, at least one Patent Owner can combine or pool patents from different technology areas into one portfolio. This provides for diversification. Pooling makes it easier to get the asset class rated by a ratings agency. Pooling makes it more attractive to equity investors.

In another embodiment for patent equity financing, there is pooling of Patent Owners. There can be at least two Patent Owners. At least one of the Patent Owners can have at least two different technology areas of patents.

This invention provides for solutions for a combined patent debt and patent equity financing solution.

In one embodiment, a Patent Owner can seek or pursue both patent debt and patent equity simultaneously at the same time. This is attractive to Lenders, since by showing progress of raising equity from equity investors (such as Series A, Series B, etc.), then Lenders see signs of positive progress and are more likely to lend money since there is a higher chance or increased likelihood to pay off the loan.

Similar to fantasy sports, a person can pick a fantasy draft of patents that will perform the best, including based on sale value, licensing revenue, royalties, etc. This fantasy draft could be just one patent from one company. It could include multiple companies. It could include multiple technology areas from one company. It could include multiple technology areas from more than one company.

If someone picks a patent to include in their fantasy sports, the patent owner (or Patent Applicant or Assignee) might choose to reward those people such as giving them rewards, incentives, dividends, cash, loyalty points, discounted or free tickets to events, coupons, or any other item or reward.

Someone could create their own portfolio of patents in fantasy sports, such as a person could select 6 patents, including Patent Owner 1 with patents A, B, C and Patent Owner 2 with patents D, E, F. Then, in the future, anyone else who selects these same 6 patents could lead to a reward being paid to this person who created this fantasy sports portfolio of patents A, B, C, D, E, F.

There could be a Bloomberg type analysis charting the performance of all patents, patent applications of individual patents and groups of patent portfolios. The Bloomberg analysis can have total value of each patent and of the portfolio or groups of patents.

In one embodiment, the patent debt financing can be rated by a rating agency, such as Moody's, Standard & Poors (S&P), Fitch Ratings, Kroll Bond Rating Agency (KBRA), DBRS, etc.

A mutual fund could include both patent and non-patent assets.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

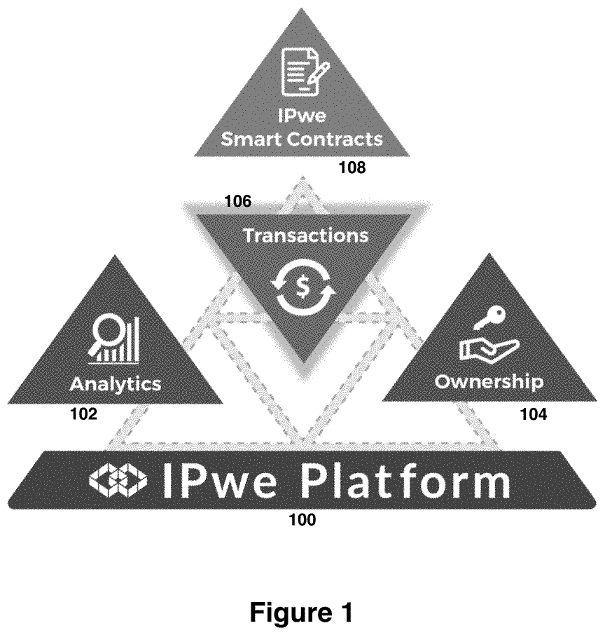

FIG. 1 is diagram of the core structure of the present invention. In accordance with the preferred embodiment of the present invention, the platform 100 is based on the core aspects of: an analytics engine 102; ip ownership 104; transactions 106; and smart contracts 108. The analytics engine 102 leverages the power of artificial intelligence to provide answers to basic and complex questions about patents, and is available free of charge on the Platform 100. The analytics engine 102 delivers immediately actionable insights and offers a suite of integrated and powerful tools unmatched in sophistication and proven results. The ownership aspect 104 is based on the Global Patent Registry (GPR), which is the first and only blockchain-enabled registry of the world's patents that provides full transparency into patent identification and ownership 104. The GPR is available free of charge and currently includes information for over 80% of the world's patents. The Smart Contracts feature 108 is implemented on Hyperledger by the world's leading experts on patent transactions. Developing smart contracts 108 for IP transactions requires a competence and expertise in blockchain and patents that few possess and even fewer can implement. The smart contracts feature 108: results in transactional 106 efficiencies and lower costs; reduces human resource requirements; promotes standardization; and acts as a built-in contract management tool.

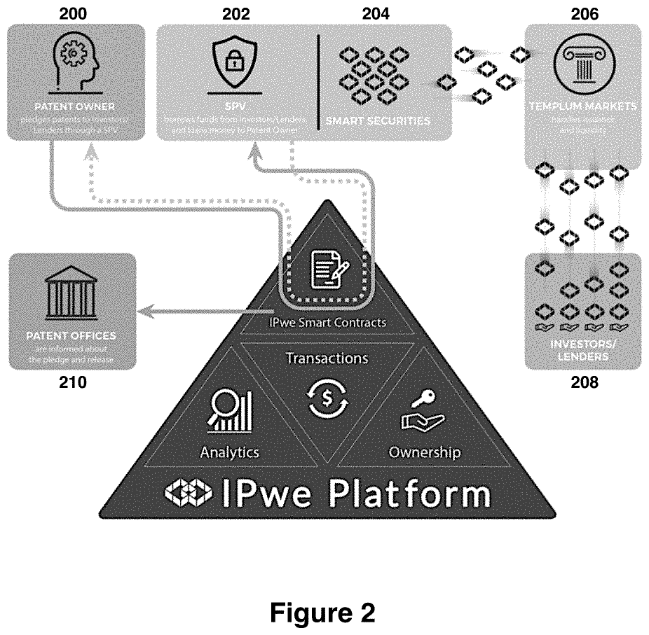

FIG. 2 is a diagram of the smart securities process for patent assets using the present invention. A patent owner 200 can establish an SPV 202 for smart securities 204 related to patent assets. Templum Markets 206 can organize the securities 204. Investor lenders 208 can purchase insurance on title at the time of purchase. Patent Offices 210 can be used to verify the color of title.

The platform itself can construct a smart contract in real time based on inputs from an inventor or patent holder. In one embodiment, the inventor submits the patent application, and the network uses an analysis engine to generate a report regarding the likelihood of patentability based on several criteria, including patentable nature of the invention, the status of prior art, and the novelty of the inventive step. The platform further provides a user to express interest in insurance, and provides a rate and insurance premium price using FIAT currency and virtual currency. The user can select the options that seem most beneficial to the user at that time.

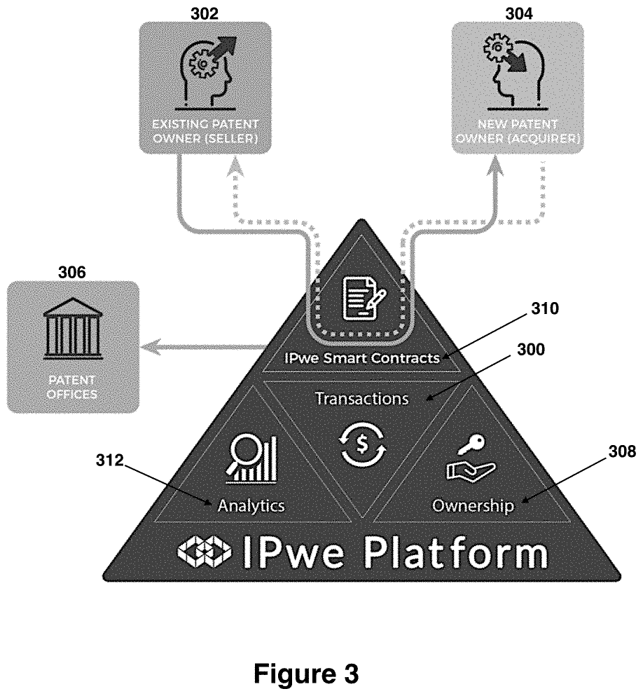

FIG. 3 is a diagram of patent sale and assignment transactions using the present invention. In accordance with the preferred embodiment of the present invention 300, the patent seller 302 sells patents to a patent acquirer 304 and receives funds from the patent sale. The patent office 306 then receives the assignment information and the global patent registry 308 is updated. The smart contracts 310 embodiment of the present invention 300 governs the identification of the patents and title updates, automatic execution of the sale including payments and reversions on default, the terms of agreement of sale, and whether the terms are made public. The present invention 300 then provides updates to the global patent registry 308, analysis of the sale 312, annuity payments, title verification, sale agreements and transactional support to the patent owner/seller 302.

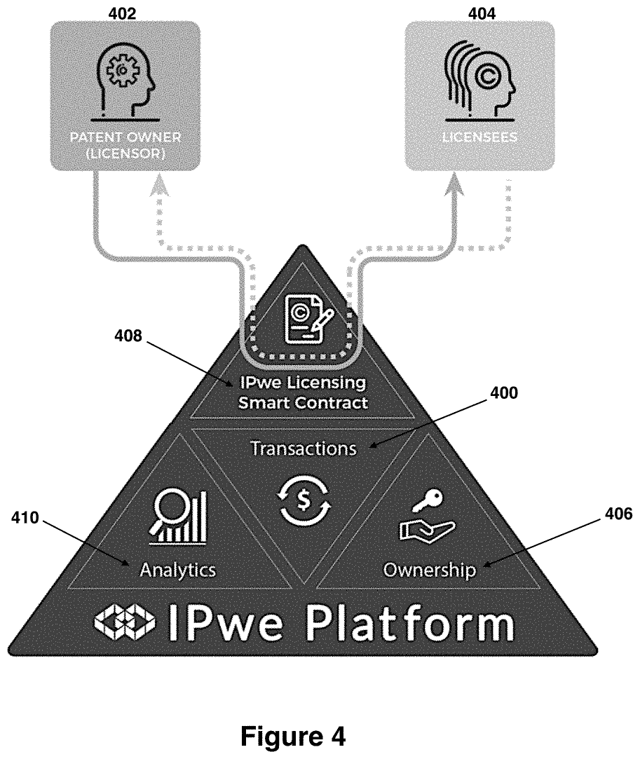

FIG. 4 is a diagram of patent licensing using the present invention. In accordance with the preferred embodiment of the present invention 400, the patent owner 402 licenses certain Licensees 404 under the selected patents. The Patent owner collects payments and royalties from the Licensees, and the licensing smart contracts embodiment 408 of the present invention is used to facilitate the identification of the patents, execution and payment of the license agreement, the terms of the license agreement, and whether any terms are made public. The present invention 400 provides an analysis 410, licensing agreements, title verification, reporting to the patent registry 406, annuity payments, royalty administration and transactional support to the patent owner 402.

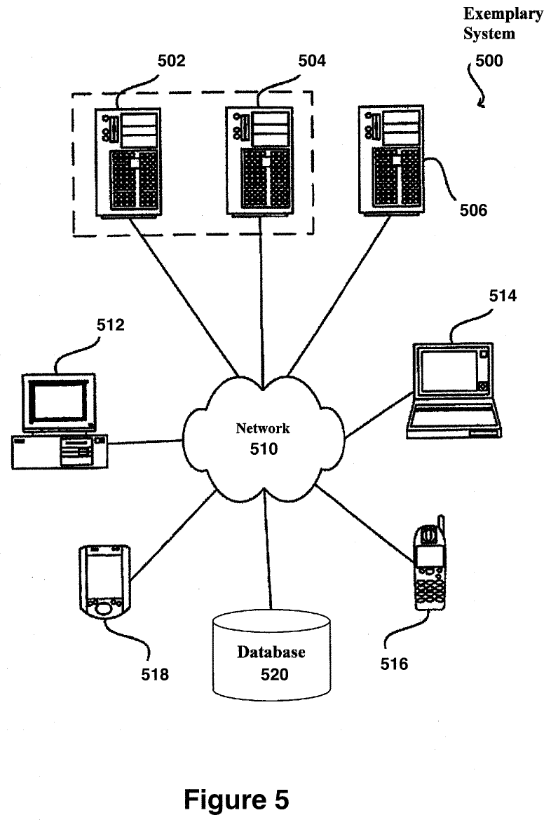

FIG. 5 is a block diagram illustrating components of an exemplary operating environment in which embodiments of the present invention may be implemented. The system 500 can include one or more user computers, computing devices, or processing devices 512, 514, 516, 518, which can be used to operate a client, such as a dedicated application, web browser, etc. The user computers 512, 514, 516, 518 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 512, 514, 516, 518 may also have any of a variety of applications, including one or more development systems, database client and/or server applications, and Web browser applications. Alternatively, the user computers 512, 514, 516, 518 may be any other electronic device, such as a thin-client computer, Internet-enabled gaming system, and/or personal messaging device, capable of communicating via a network (e.g., the network 510 described below) and/or displaying and navigating Web pages or other types of electronic documents. Although the exemplary system 500 is shown with four user computers, any number of user computers may be supported.

In most embodiments, the system 500 includes some type of network 510. The network can be any type of network familiar to those skilled in the art that can support data communications using any of a variety of commercially-available protocols, including without limitation TCP/IP, SNA, IPX, AppleTalk, and the like. Merely by way of example, the network 510 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 502, 504, 506 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 506) may be dedicated to running applications, such as a business application, a Web server, application server, etc. Such servers may be used to process requests from user computers 512, 514, 516, 518. The applications can also include any number of applications for controlling access to resources of the servers 502, 504, 506.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 512, 514, 516, 518. As one example, a server may execute one or more Web applications. The Web application may be implemented as one or more scripts or programs written in any programming language, such as Java.®, C, C# or C++, and/or any scripting language, such as Perl, Python, or TCL, as well as combinations of any programming/scripting languages. The server(s) may also include database servers, including without limitation those commercially available from Oracle.®, Microsoft.®, Sybase.®, IBM.® and the like, which can process requests from database clients running on a user computer 512, 514, 516, 518.

The system 500 may also include one or more databases 520. The database(s) 520 may reside in a variety of locations. By way of example, a database 520 may reside on a storage medium local to (and/or resident in) one or more of the computers 502, 504, 506, 512, 514, 516, 518. Alternatively, it may be remote from any or all of the computers 502, 504, 506, 512, 514, 516, 518, and/or in communication (e.g., via the network 510) with one or more of these. In a particular set of embodiments, the database 520 may reside in a storage-area network (“SAN”) familiar to those skilled in the art. Similarly, any necessary files for performing the functions attributed to the computers 502, 504, 506, 512, 514, 516, 518 may be stored locally on the respective computer and/or remotely, as appropriate. In one set of embodiments, the database 520 may be a relational database, such as Oracle 10g, that is adapted to store, update, and retrieve data in response to SQL-formatted commands.

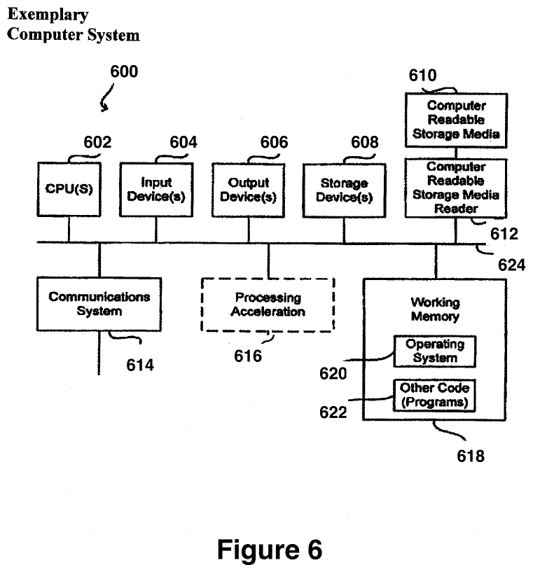

FIG. 6 illustrates an exemplary computer system 600, in which embodiments of the present invention may be implemented. The system 600 may be used to implement any of the computer systems described above. The computer system 600 is shown comprising hardware elements that may be electrically coupled via a bus 624. The hardware elements may include one or more central processing units (CPUs) 602, one or more input devices 604 (e.g., a mouse, a keyboard, etc.), and one or more output devices 606 (e.g., a display device, a printer, etc.). The computer system 600 may also include one or more storage devices 608. By way of example, the storage device(s) 608 can include devices such as disk drives, optical storage devices, solid-state storage device such as a random access memory (“RAM”) and/or a read-only memory (“ROM”), which can be programmable, flash-updateable and/or the like.

The computer system 600 may additionally include a computer-readable storage media reader 612, a communications system 614 (e.g., a modem, a network card (wireless or wired), an infra-red communication device, etc.), and working memory 618, which may include RAM and ROM devices as described above. In some embodiments, the computer system 600 may also include a processing acceleration unit 616, which can include a digital signal processor DSP, a special-purpose processor, and/or the like.

The computer-readable storage media reader 612 can further be connected to a computer-readable storage medium 610, together (and, optionally, in combination with storage device(s) 608) comprehensively representing remote, local, fixed, and/or removable storage devices plus storage media for temporarily and/or more permanently containing, storing, transmitting, and retrieving computer-readable information. The communications system 614 may permit data to be exchanged with the network and/or any other computer described above with respect to the system 600.

The computer system 600 may also comprise software elements, shown as being currently located within a working memory 618, including an operating system 620 and/or other code 622, such as an application program (which may be a client application, Web browser, mid-tier application, RDBMS, etc.). It should be appreciated that alternate embodiments of a computer system 600 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 6 further illustrates an environment where an on-demand distributed database service might be used. As illustrated in FIG. 6 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium.® processor or the like. Similarly, a computer system (and additional instances of an enterprise database, where more than one is present) and all of their components might be operator configurable using application(s) including computer code run using a central processing unit such as an Intel Pentium.® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

The above illustrations provide many different embodiments for implementing different features of the invention. Specific embodiments of components and processes are described to help clarify the invention. These are, of course, merely embodiments and are not intended to limit the invention from that described in the claims.

Persons of ordinary skill in the art will realize that the foregoing description is illustrative only and not in any way limiting. Other modifications and improvements will readily suggest themselves to such skilled persons having the benefit of this disclosure.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removable or remotely coupled to an information processing system. The computer readable media may include, for example and without limitation, any number of the following: magnetic storage media including disk and tape storage media; optical storage media such as compact disk media (e.g., CD ROM, CD R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of.”

What is claimed is:

1. A system for transacting intellectual property rights comprising:
a blockchain communication medium for capturing and disseminating information related to the scope and validity of said intellectual property debt financing rights;
a broadcasting interface connected to said blockchain medium for original holders of said intellectual property rights to create a market for said rights;
a multiplicity of receiver interfaces connected to said blockchain medium for prospective holders of said intellectual property rights to evaluate said rights for the purpose of deciding whether said prospective holders will acquire an interest in said intellectual property rights by creating a final decision, including pooling patents from various technology areas together to ascertain and determine ratings for use by various potential investors in said rights; and
an intelligent evaluation technique provided by an intellectual property asset class manager for assisting said prospective holders of said intellectual property rights as to whether said prospective holders will acquire said intellectual property rights from said original holders of said intellectual property rights by way of said final decision based on said scope and said validity of said intellectual property rights.

2. A system according to claim 1 wherein said rights are licensing rights.

3. A system according to claim 1 wherein said rights are ownership rights.

4. A system according to claim 1 wherein said intelligent evaluation techniques utilize artificially intelligent data evaluation engines.

5. A system according to claim 1 wherein said holder and said prospective holders of intellectual property rights transact business by way of cryptocurrency.

6. A system according to claim 5 wherein said business transacted is transacted by way of a smart blockchain contract.

7. A system according to claim 1 for intellectual portfolio management for said holders and said prospective holder of intellectual property rights including making annuity payments, searching said intellectual property rights, brokering said intellectual property rights and providing a deal interface pursuant to applicable compliance guidelines.

8. A system according to claim 7 wherein patent-based finance, insurance and risk mitigation solutions are provided for said holders of intellectual property rights.

9. A method for transacting intellectual property rights comprising the steps of:
forming a blockchain communication medium for capturing and disseminating information related to the scope and validity of said intellectual property rights;
broadcasting via an interface connected to said blockchain medium information pertaining to said intellectual property rights from original holders of said intellectual property rights to create a market for said rights;
formatting a multiplicity of receiver interfaces connected to said blockchain medium for prospective holders of said intellectual property rights to evaluate said rights for the purpose of deciding whether said prospective holders will acquire an interest in said intellectual property rights by creating a final decision, including evaluating pools of patent rights acquired from various relevant technologies; and
performing an intelligent evaluation technique provided by an intellectual property asset class manager for assisting said prospective holders of said intellectual property rights as to whether said prospective holders will acquire said intellectual property rights from said original holders of said intellectual property rights by way of said final decision based on said scope and said validity of said intellectual property rights.

10. A method according to claim 9 wherein said rights are licensing rights.

11. A method according to claim 9 wherein said rights are ownership rights.

12. A method according to claim 9 wherein said intelligent evaluation techniques utilize artificially intelligent data evaluation engines.

13. A method according to claim 9 wherein said holder and said prospective holders of intellectual property rights transact business by way of cryptocurrency.

14. A method according to claim 13 wherein said business transacted is transacted by way of a smart blockchain contract.

15. A method according to claim 9 for intellectual portfolio management for said holders and said prospective holder of intellectual property rights including making annuity payments, searching said intellectual property rights, brokering said intellectual property rights and providing a deal interface pursuant to applicable compliance guidelines.

16. A method according to claim 15 wherein patent-based finance, insurance and risk mitigation solutions are provided for said holders of intellectual property rights.
